(19) United States
(12) Patent Application Publication
(10) Pub. No.: US 2013/0170884 A1
(43) Pub. Date: Jul. 4, 2013

(54) INPUT DEVICE

(71) Applicant: GETAC TECHNOLOGY CORPORATION, Hsinchu (TW)

(72) Inventor: Hsin-Chih Chou, Taipei City (TW)

(73) Assignee: GETAC TECHNOLOGY CORPORATION, Hsinchu (TW)

(21) Appl. No.: 13/712,886

(22) Filed: Dec. 12, 2012

Related U.S. Application Data
(60) Provisional application No. 61/581,506, filed on Dec. 29, 2011.

(30) Foreign Application Priority Data
Apr. 24, 2012 (CN) 201210121995.8

(51) Int. Cl. G06F 3/02

(52) U.S. Cl. CPC G06F 3/0202
USPC 400/495

(57) ABSTRACT

An input device in an environment where pressure changes. The input device comprises a plate layer, a circuit layer, a keypad layer, a protection layer, and a sealed and liquid-tight space. The keypad layer is attached to the plate layer. The sealed and liquid-tight space is formed between the plate layer and the keypad layer. The circuit layer is disposed in the sealed and liquid-tight space. Furthermore, the plate layer has a first hole, and the circuit layer has a second hole corresponding to the first hole. The protection layer is attached to the plate layer and corresponds to the sealed and liquid-tight space. The air permeable rate of the protection layer is between 10% and 50% so that the inside pressure and the outside pressure of the input device can reach an equilibrium.

### BACKGROUND

1. Technical Field

The disclosure relates to an input device, and more particularly to an input device which is adapted in an environment where pressure changes.

2. Related Art

Nowadays, computers are used widely, and keyboard is one of main input devices using in computers. Conventional keyboard is not liquid-proof and dust-proof. Therefore, dirty materials are easily accumulated after a long time usage. In addition, if a user splashes liquid, such as water, to the keyboard by accident, liquid may damage the keyboard.

In order to avoid damages caused by liquid or dust, silica gel or rubber keyboards with good liquid proof and sealing characteristics have been designed. However, in an environment where temperature or pressure changes greatly, the deformation of the silica gel or rubber keyboards may occur due to changes of temperature or pressure. Furthermore, an input signal might be unexpectedly triggered due to deformation of the keyboard.

### SUMMARY

An input device in an environment where pressure changes is disclosed. The input device comprises a plate layer having a first hole, a circuit layer disposed on the plate layer, a keypad layer disposed on the plate layer, and a protection layer attached to the plate layer. The circuit layer has at least one second hole corresponding to the first hole. The keypad layer covers the circuit layer. A protection layer is attached to the plate layer and corresponds to the first hole. The air permeable rate of the protection layer is between 10% and 50%. A sealed and liquid-tight space is formed between the plate layer and the keypad layer for air flowing.

### BRIEF DESCRIPTION OF THE DRAWINGS

The present disclosure will become more fully understood from the detailed description given herein below for illustration only, and thus are not limitative of the present disclosure, and wherein:

FIG. 1 illustrates an input device according to an embodiment;

FIG. 2 is an exploded view of the input device in FIG. 1;

FIG. 3 is a sectional view of the input device in FIG. 1;

FIG. 4 is a sectional view of an input device according to another embodiment;

FIG. 5 is a sectional view of an input device according to yet another embodiment; and

FIG. 6 is a sectional view of an input device according to still another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

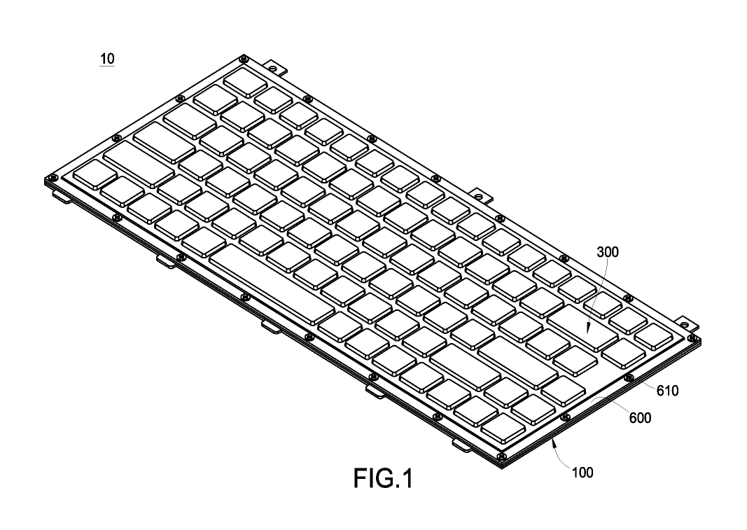

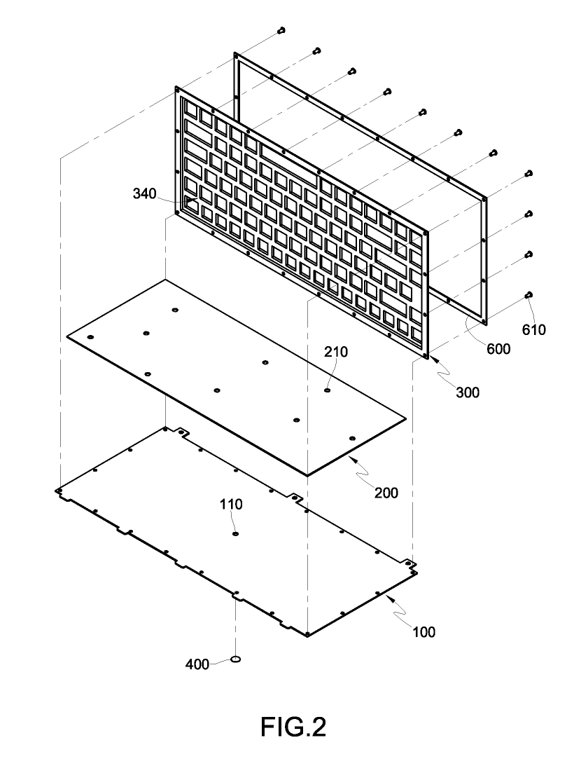

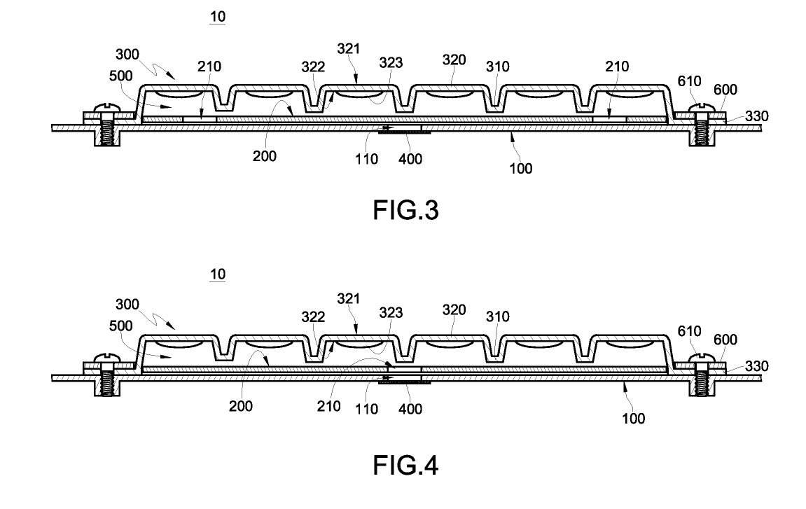

Please refer to FIGS. 1 to 3. FIG. 1 illustrates an input device according to an embodiment. FIG. 2 is an exploded view of the input device in FIG. 1. FIG. 3 is a sectional view of the input device in FIG. 1. The input device 10 in this embodiment can be used in an environment where differential pressure or differential temperature changes. However, the disclosure is not limited this way. The environment where differential pressure or differential temperature changes refers to an environment where the altitude changes greatly in a short time, for example, airplane cabin during flight, or cabin in a sailing submarine. Furthermore, the input device 10 may be but is not limited to be a keyboard.

The input device 10 of this embodiment comprises a plate layer 100, a circuit layer 200, a keypad layer 300, a protection layer 400, and a sealed and liquid-tight space 500. The plate layer 100 has a first hole 110. The circuit layer 200 is disposed on the plate layer 100. The circuit layer 200 has a plurality of second holes 210 corresponding to the first hole 110. Here, the term “corresponding to” means any of the following situations: a second hole 210 is completely overlapped with the first hole 110; a second hole 210 is partly overlapped with the first hole 110; and the second hole 210 is not overlapped with the first hole 110. In this embodiment, none of the second holes 210 is overlapped with the first hole 110, but the disclosure is not limited to this embodiment.

The keypad layer 300 disposed on the plate layer 100 covers the circuit layer 200. More particularly, the sealed and liquid-tight space 500 is formed between the plate layer 100 and the keypad layer 300 for air flowing. The circuit layer 200 is disposed in the sealed and liquid-tight space 500.

The protection layer 400 may be a liquid-proof and air permeable adhesive tape. The protection layer 400 is attached to the plate layer 100 and corresponds to the first hole 110. In other words, the protection layer 400 is pasted on the first hole 110 so that the sealed and liquid-tight space 500 covered by the protection layer 400 is liquid-proof and air permeable. As a result, air but not liquid can go into the sealed and liquid-tight space 500 through the protection layer 400, so to resist dust and liquid. The air permeable rate of the protection layer 400 is between 10% and 50%. The air permeable rate refers to the ratio of air passing through the protection layer 400 per unit area.

In this embodiment, the keypad layer 300 is formed as a whole by soft materials such as silica gel or rubber. The keypad layer 300 comprises a body 310 and a plurality of key caps 320 which protrude from the body 310. The key caps 320 protrude far away from the plate layer 100. The body 310 has an accommodating sink 340. The accommodating sink 340 and the key caps 320 are disposed at two opposite sides of the body 310, respectively. The circuit layer 200 is disposed in the accommodating sink 340. Furthermore, the body 310 has a ring edge 330 surrounding the main portion of the body. The ring edge 330 is attached to the plate layer 100.

Each key pad 320 has a keystroke face 321 and a triggering face 322 which are opposite to each other. The keystroke face 321 is used for users to press. The triggering face 322 faces to the circuit layer 200. A conductor 323 is disposed on the trigger face 322 of each key cap. Conductors 323 correspond to the circuit layer 200. When a conductor 323 is electrically connected with the circuit layer 200, an input signal is triggered and the input signal can be transmitted to an electronic device via wired or wireless transmission interfaces.

In this embodiment, by connecting the protection layer 400 to the sealed and liquid-tight space 500, the inside and the outside temperature or pressure of the input device can reach an equilibrium. In this case, deformation of the keypad layer 300 due to differential temperature or differential pressure can be avoided. Furthermore, it shall be ensured that the conductor 323 of the key pad 320 will not contact with the circuit layer 200 by mistake and causes an unanticipated input signal.

In this or other embodiments, the input device 10 further comprises a compression ring 600 and a plurality of jointing elements 610. The compression ring is attached to the ring edge 330 so that the ring edge is between the compression ring 600 and the plate layer 100. The jointing elements 610 penetrate the compression ring 600, the ring edge 330, and the plate layer 100, so that the compression ring 600, the ring edge 330, and the plate layer 100 are bonded tightly. As a result, the outside liquid cannot flow into the sealed and liquid-tight space 500 through the gap between the keypad layer 300 and the plate layer 100. The jointing element 610 may be, for example, a screw. In other embodiments, the ring edge 330 can be attached to the plate layer 100 by adhesive. However, the disclosure is not limited by the embodiments.

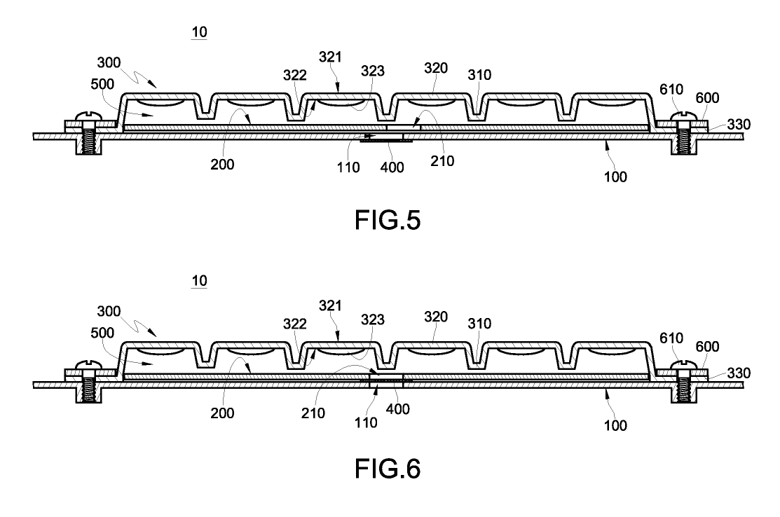

In this and other embodiments, the number of the second holes 210 can be various in the input device 10. FIG. 4 is a sectional view of an input device 10 according to another embodiment. FIG. 5 is a sectional view of an input device 10 according to yet another embodiment. The structures of the input devices in FIGS. 4 and 5 are similar to the structure of the input device in FIG. 1. The differences are set forth as below. In FIG. 4, the circuit layer 200 only has one second hole 210 which is overlapped with the first hole 110. In FIG. 5, the circuit layer 200 only has one second hole 210 which is partly overlapped with the first hole 110.

FIG. 6 is a sectional view of an input device 10 according to still another embodiment. In FIG. 3, the protection layer 400 is disposed outside of the sealed and liquid-tight space 500. Alternatively, the protection layer 400 can be disposed in the sealed and liquid-tight space 500 and corresponds to the first hole 110.

According the above described input devices, by connecting the sealed and liquid-tight space to the liquid-proof and air-permeable protection layer, the sealed and liquid-tight space covered by the protection layer is liquid-proof and air permeable. So, the input device can resist dust and liquid, and the temperature and the pressure differences between inside and outside of the input device can be rapidly in equilibrium. Thus, deformation of the keypad layer due to differential temperature or pressure can be avoided as well as to ensure that the keypad layer will not contact with the circuit layer by mistake which would cause an unanticipated input signal.

Although embodiments are disclosed as above, they are not intended to limit the scope of disclosure. It should be understood that various alternations and modifications without departing from the spirit and scope of the disclosure are included in the scope as defined by the appended claims.

What is claimed is:

1. An input device in an environment where pressure changes, comprising:
a plate layer having a first hole;
a circuit layer disposed on the plate layer, having at least one second hole corresponding to the first hole;
a keypad layer disposed on the plate layer, covering the circuit layer;
a protection layer attached to the plate layer, corresponding to the first hole and having a air permeable rate between 10% and 50%; and
a sealed and liquid-tight space formed between the plate layer and the keypad layer for air flowing.

2. The input device according to claim 1, wherein the keypad layer comprises a body and a plurality of key caps protruding from the body, and a plurality of key caps protrude far away from the plate layer.

3. The input device according to claim 2, wherein each of the plurality of key caps has a keystroke face and a triggering face opposite to each other.

4. The input device according to claim 3, wherein each of the plurality of key caps has a conductor disposed on the triggering face, and said conductor corresponds to said circuit layer.

5. The input device according to claim 2, wherein the body has a ring edge surrounding main portion of the body, and the ring edge is attached to the plate layer.

6. The input device according to claim 5, further comprising a compression ring and a plurality of jointing elements, wherein said compression ring is attached to the ring edge, the ring edge is between the compression ring and the plate layer, and said plurality of joining elements penetrate the compression ring, the ring edge and the plate layer so to make the compression ring, the ring edge, and the plate bonded tightly.

7. The input device according to claim 2, wherein the body has an accommodating sink, the accommodating sink and the plurality of key caps are disposed at opposite sides of the body respectively, and the circuit layer is disposed in the accommodating sink.

8. The input device according to claim 1, wherein the first hole is overlapped with the second hole.

9. The input device according to claim 1, wherein the circuit layer has a plurality of the second holes, and the first hole is overlapped with the at least one second hole.

10. The input device according to claim 1, wherein the first hole is partly overlapped with the second hole.
